(19) United States
(12) Patent Application Publication
(10) Pub. No.: US 2006/0227756 A1
(43) Pub. Date: Oct. 12, 2006

(54) Method and system for securing media content in a multimedia processor

(76) Inventors: Viresh Rustagi, Sunnyvale, CA (US); Christopher Wilson, Sunnyvale, CA (US); Christopher Boross, Palo Alto, CA (US)

Correspondence Address: MCANDREWS HELD & MALLOY, LTD, 500 WEST MADISON STREET, SUITE 3400, CHICAGO, IL, 60661, US

(21) Appl. No.: 11/400,158

(22) Filed: Apr. 6, 2006

Related U.S. Application Data
(60) Provisional application No. 60/669,223, filed on Apr. 6, 2005.
(60) Provisional application No. 60/750,246, filed on Dec. 14, 2005.

(51) Int. Cl. H04B 7/216

(52) U.S. Cl. 370/342

(57) ABSTRACT

Methods and systems for processing video data are disclosed herein and may comprise receiving in a single mobile multimedia processor chip at least one indicator relating to how input multimedia data is processed. A further indicator may be generated within the single mobile multimedia processor chip, based on the at least one indicator, which identifies whether output data generated from the input multimedia data is secure. The at least one indicator may comprise a first indicator, which identifies whether an instruction cache is used to process the current instruction, a second indicator, which identifies whether an interrupt is used to process the current instruction, and a third indicator, which specifies a program counter value associated with the current instruction. A secure bit may be generated within the single mobile multimedia processor chip, based on the received first, second and third indicators, and on other internal state.

### CROSS-REFERENCE TO RELATED APPLICATIONS/INCORPORATION BY REFERENCE

This application makes reference, claims priority to, and claims the benefit of U.S. Provisional Application Ser. No. 60/669,223 filed Apr. 6, 2005, which is hereby incorporated herein by reference in its entirety.

This application makes reference, claims priority to, and claims the benefit of U.S. Provisional Application Ser. No. 60/750,246 filed Dec. 14, 2005, which is hereby incorporated herein by reference in its entirety.

### FIELD OF THE INVENTION

Certain embodiments of the invention relate to mobile multimedia communication. More specifically, certain embodiments of the invention relate to secure conditional access and digital rights management in a multimedia processor.

### BACKGROUND OF THE INVENTION

Mobile communications have changed the way people communicate and mobile phones have been transformed from a luxury item to an essential part of every day life. The use of mobile phones today is dictated by social situations, rather than hampered by location or technology. While voice connections fulfill the basic need to communicate, and mobile voice connections continue to filter even further into the fabric of every day life, various integrated mobile multimedia applications, utilizing the mobile Internet, are the next step in the mobile communication revolution.

Third generation (3G) cellular networks offering various high speed access technologies and mobile telephones that have been specifically designed to utilize these technologies, fulfill demands for integrated multimedia applications supporting TV and audio applications utilizing advanced compression standards, high-resolution gaming applications, musical interfaces, peripheral interface support, etc. The processing requirements are being increased as chip designers take advantage of compression and higher bandwidths to transmit more information. 3G wireless applications support bit rates from 384 kilobits (Kbits)/second to 2 megabits (Mbits)/second, allowing chip designers to provide wireless systems with multimedia capabilities, superior quality, reduced interference, and a wider coverage area.

As mobile multimedia services grow in popularity and usage, factors such as power consumption, cost efficient optimization of network capacity and quality of service (QoS) are becoming even more essential to cellular operators than they are today. These factors may be achieved with careful network planning and operation, improvements in transmission methods, and advances in receiver techniques and chip integration solutions. To this end, carriers need technologies that will allow them to increase downlink throughput for the mobile multimedia applications support and, in turn, offer advanced QoS capabilities and speeds for consumers of mobile multimedia application services. Currently, mobile multimedia processors don't fully exploit system-on-a-chip (SOC) integration for advanced total system solution for today's mobile handsets.

For example, conventional mobile processors may utilize a plurality of hardware accelerators to enable a variety of multimedia applications, which significantly increases power consumption, implementation complexity, mobile processor real estate, and ultimately terminal size. In addition, conventional mobile multimedia processors do not provide a secure platform for conditional access and digital rights management. Multimedia content is decrypted outside the mobile multimedia processor and is exposed to potential hackers when the decrypted content is communicated to the mobile multimedia processor for processing.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for secure conditional access and digital rights management in a multimedia processor, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1A is a block diagram of an exemplary mobile multimedia system, in accordance with an embodiment of the invention.

FIG. 1B is a block diagram illustrating security boundaries within an exemplary mobile multimedia system, in accordance with an embodiment of the invention.

FIG. 2 is a block diagram of an exemplary mobile multimedia system, which may be utilized in accordance with an embodiment of the invention.

FIG. 3 is a block diagram of an exemplary single mobile multimedia processor chip, in accordance with an embodiment of the invention.

FIG. 4 is a block diagram of an exemplary secure mode controller, which may be utilized in accordance with an embodiment of the invention.

FIG. 5 is a block diagram illustrating secure memory utilization within an exemplary single mobile multimedia processor chip, in accordance with an embodiment of the invention.

FIG. 6 is a block diagram of an exemplary secure storage (SS) block, which may be utilized in accordance with an embodiment of the invention.

FIG. 7 is a flow diagram illustrating exemplary steps for stage 1, stage 2 and stage 3 boot code sequences, in accordance with an embodiment of the invention.

FIG. 8 is a flow diagram illustrating exemplary steps for processing data, in accordance with an embodiment of the invention.

### DETAILED DESCRIPTION OF THE INVENTION

Certain embodiments of the invention may be found in a method and system for secure conditional access and digital rights management in a single mobile multimedia processor chip in a mobile multimedia system. In one embodiment of the invention, one or more security boundaries may be established within the single mobile multimedia processor chip, thereby preventing access by a potential hacker to secure key content, decrypted multimedia content, and/or critical operation code within the single mobile multimedia processor chip. The security boundaries may comprise physical boundaries within the mobile multimedia system in which one or more processing blocks within the boundary may be designated as secure and other blocks outside the boundary may be designated as unsecure. For example, a host processor may be located outside a secure boundary, such as a secure kernel, and may be designated as unsecure. In this regard, any communications received from an unsecure block may be considered unsecure. The security boundaries may also comprise boundaries that vary in time in which one or more blocks within the mobile multimedia system, at different instants, may be designated as either secure blocks or unsecure blocks. In an exemplary embodiment of the invention, a secure bit may be asserted within information communicated from a secure source, such as a block within a secure boundary within the single mobile multimedia processor chip. Similarly, a secure bit may be de-asserted within information communicated from unsecure source, such as a block outside a secure boundary within the single mobile multimedia processor chip.

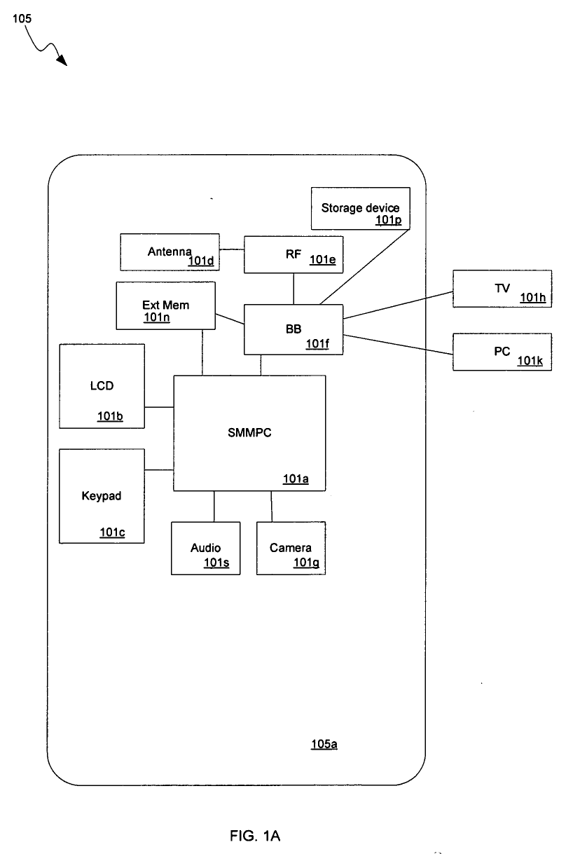

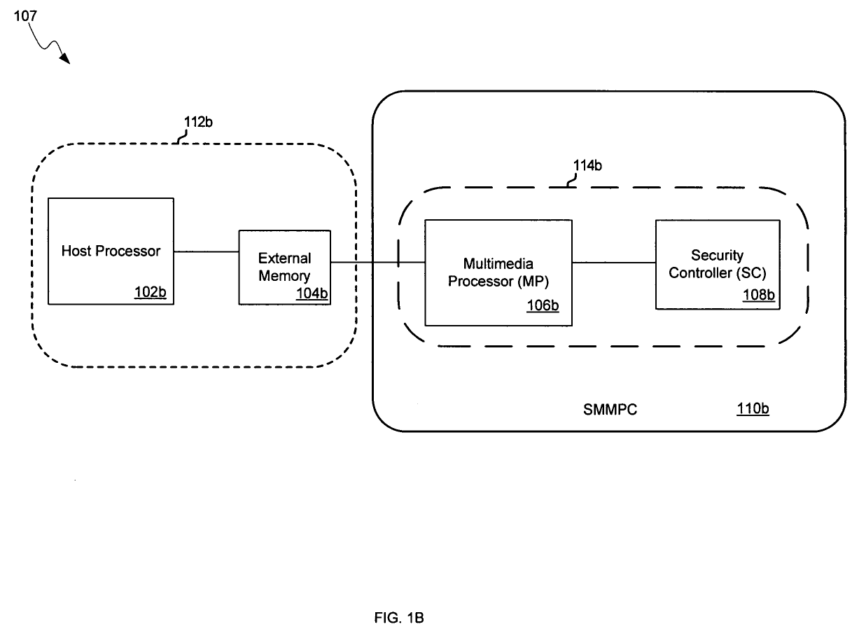

FIG. 1A is a block diagram of an exemplary mobile multimedia system, in accordance with an embodiment of the invention. Referring to FIG. 1A, there is shown a mobile multimedia system 105 that comprises a mobile multimedia device 105a, a TV 101h, and a PC 101k. The mobile multimedia device 105a may be a cellular telephone or other handheld communication device. The mobile multimedia device 105a may comprise a single mobile multimedia processor chip (SMMPC) 101a, an antenna 101d, an audio block 101s, a storage device 101p, an external memory 101n, a radio frequency (RF) block 101e, a baseband processing block 101f, an LCD display 101b, a keypad 101c, and a camera 101g.

The SMMPC 101a may comprise suitable circuitry, logic, and/or code and may be adapted to perform video and/or multimedia processing for the mobile multimedia device 105a. The SMMPC 101a may further comprise a plurality of integrated interfaces, which may be utilized to support one or more external devices coupled to the mobile multimedia device 105a. For example, the SMMPC 101a may support connections to a TV 101h and/or to a PC 101k.

In operation, the mobile multimedia device may receive signals via the antenna 101d. Received signals may be processed by the RF block 101e and the RF signals may be converted to baseband by the baseband processing block 101f. Baseband signals may then be processed by the SMMPC 101a. Audio and/or video signals may also be received via the integrated camera 101g and/or the PC 101k. During processing, the SMMPC 101a may utilize the external memory 101n for storing of processed data. Processed audio data may be communicated to the audio block 101s and processed video data may be communicated to the LCD 101b or the TV 101h, for example. The keypad 101c may be utilized for communicating processing commands and/or other data, which may be required for audio or video data processing by the SMMPC 101a.

In one embodiment of the invention, the SMMPC 101a may be adapted to receive a secure key from an off-chip device. An on-chip key stored within the SMMPC 101a may be utilized for decryption of the received secure key. The decrypted and received secure key may then be stored within the SMMPC 101a. Furthermore, encrypted multimedia content may be received by the mobile multimedia device 105a via the antenna 101d. The received, encrypted multimedia content may be decrypted within the SMMPC 101a using the stored decrypted received secure key. The on-chip key may be stored within a one-time programmable (OTP) memory in the SMMPC 101a. The stored on-chip key may be retrieved from the OTP memory for the decrypting of the secure key. The stored, decrypted and received secure key may be encrypted utilizing the on-chip key stored within the SMMPC 101a.

FIG. 1B is a block diagram illustrating security boundaries within an exemplary mobile multimedia system, in accordance with an embodiment of the invention. Referring to FIG. 1B, the mobile multimedia system 107 may comprise a host processor 102b, an external memory 104b, and a single mobile multimedia processor chip 110b. The single mobile multimedia processor chip 110b may comprise a multimedia processor (MP) 106b and a security controller (SC) 108b.

The host processor 102b may comprise suitable circuitry, logic, and/or code and may be adapted to handle application level processing of information for the mobile multimedia system 107. The single mobile multimedia processor chip 110b may comprise suitable circuitry, logic, and/or code and may be adapted to handle processing of multimedia content, such as decryption and/or decoding of encrypted and/or encoded multimedia content, as well as security-related tasks associated with decrypted and decoded multimedia content. For example, the multimedia processor (MP) 106b within the single mobile multimedia processor chip 110b may comprise suitable circuitry, logic, and/or code and may be adapted to handle decryption and decoding of multimedia content. The SC 108b may comprise suitable circuitry, logic, and/or code and may be adapted to perform security functions related to decrypted and decoded multimedia content within the single mobile multimedia processor chip 110b.

In an exemplary embodiment of the invention, one or more security boundaries may be established within the mobile multimedia system 107, thereby preventing access by a potential hacker to secure key content, decrypted multimedia content, and/or critical operation code within the single mobile multimedia processor chip 110b. The security boundaries may comprise physical boundaries within the mobile multimedia system 107, in which one or more processing blocks within the boundary may be designated as secure and other blocks outside the boundary may be designated as unsecure. For example, the host processor 102b and the external memory 104b may be located within area 112 that is outside a secure boundary 114b. In this regard, the MP 106b and the SC 108b, which are within the secure boundary 114b, may be designated as secure. The host processor 102b and the external memory 104b, which are located outside the secure area 114b, may be designated as unsecure. Any communications received from an unsecure block, such as the host processor 102b or the external memory 104b, may be considered unsecure. In another embodiment of the invention, the security boundary 114b may comprise a boundary that varies in time. In this regard, the MP 106b and the SC 108b, which are located within the boundary 114b, at different instants, may be designated as either secure blocks or unsecure blocks.

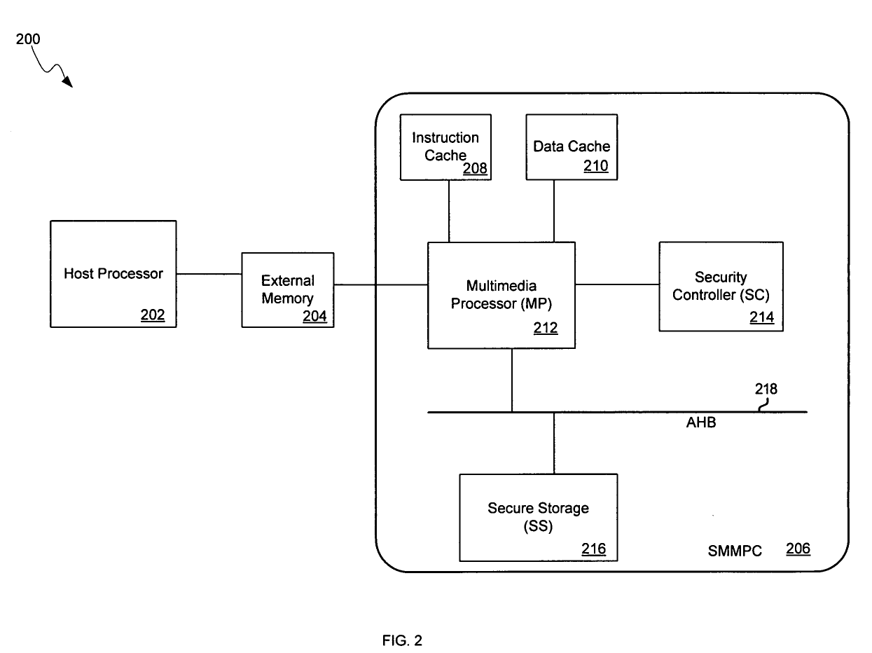

FIG. 2 is a block diagram of an exemplary mobile multimedia system, which may be utilized in accordance with an embodiment of the invention. Referring to FIG. 2, the mobile multimedia system 200 may comprise a host processor 202, an external memory 204, and a single mobile multimedia processor chip 206. The single mobile multimedia processor chip 206 may comprise instruction cache 208, data cache 210, a multimedia processor (MP) 212, a security controller (SC) 214, an advanced high performance bus (AHB) 218, and a secure storage (SS) block 216.

The host processor 202 may comprise suitable circuitry, logic, and/or code and may be adapted to handle application level processing of information for the mobile multimedia system 200. The single mobile multimedia processor chip 206 may comprise suitable circuitry, logic, and/or code and may be adapted to handle processing of multimedia content, such as decryption and/or decoding of encrypted and/or encoded multimedia content, as well as security-related tasks associated with decrypted and decoded multimedia content. For example, the multimedia processor (MP) 212 within the single mobile multimedia processor chip 206 may comprise suitable circuitry, logic, and/or code and may be adapted to handle decryption and decoding of multimedia content. The instruction cache 208 may be adapted to store one or more instructions, which may be utilized by the MP 212 during decryption and/or decoding. The data cache 210 may be adapted to store data during processing of the multimedia content.

The SC 214 may comprise suitable circuitry, logic, and/or code and may be adapted to perform security functions related to decrypted and decoded multimedia content within the single mobile multimedia processor chip 206. For example, the SC 214 may be adapted to control whether one or more blocks within the single mobile multimedia processor chip 206 and/or within the mobile multimedia system 200 may be designated as trusted or un-trusted for handling decrypted and decoded multimedia content. In an exemplary embodiment of the invention, the SC 214 may be adapted to receive a plurality of indicators from the MP 212 and generate a secure bit indicator in response to the received plurality of indicators and to state stored within the SC 214. The SC 214 may secure the multimedia content processed by the MP 212 by setting a bit, for example, on the AHB bus in accordance with the generated secure bit indicator. For example, if the bit is asserted, the current bus transaction may be considered secure and the source of the transaction may be considered trusted. If the bit is not asserted, the bus transaction may be considered unsecure and the source of the transaction may be considered untrusted.

The SS block 216 may comprise suitable circuitry, logic, and/or code and may be adapted to utilize one or more decryption algorithms, such as data encryption standard (DES) or triple DES (3DES), to facilitate multimedia content decryption by the MP 212. Furthermore, the SS block 216 may be utilized by the MP 212 as storage for one or more secure keys that may be utilized for decryption of encrypted multimedia content.

In operation, multimedia content may be communicated for processing from the external memory 204 to the MP 212 within the single mobile multimedia processor chip 206. The MP 212 may utilize the instruction cache 208, the data cache 210 and the SS block 216 during decryption and decoding of the received encrypted and encoded multimedia content. Furthermore, the MP 212 may communicate a plurality of indicators to the SC 214 for determination of a secure bit indicator. For example, the MP 212 may communicate a first indicator, which may identify whether the instruction cache 208 was used to process the current instruction. The MP 212 may also communicate a second indicator, which may identify whether an interrupt was used to process the current instruction. In addition, the MP 212 may communicate a third indicator to the SC 214, which may specify a program counter value associated with the current instruction. The SC 214 may then generate the secure bit indicator based on the received first indicator, second indicator, and third indicator. Processed data, such as multimedia content decrypted and decoded by the MP 212, may be communicated to one or more blocks within the single mobile multimedia processor chip 206 via the AHB 218. The SC 214 may assert or de-assert a bit within processed data communicated via the AHB 218, based on the generated secure bit indicator.

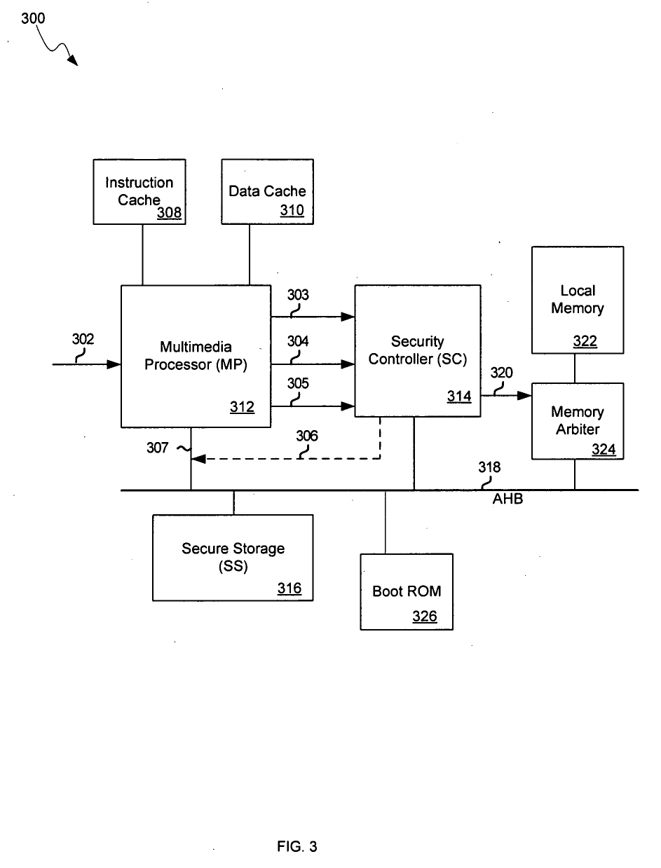

FIG. 3 is a block diagram of an exemplary single mobile multimedia processor chip, in accordance with an embodiment of the invention. Referring to FIG. 3, the single mobile multimedia processor chip 300 may comprise instruction cache 308, data cache 310, a multimedia processor (MP) 312, a security controller (SC) 314, an advanced high performance bus (AHB) 318, a secure storage (SS) block 316, a boot read only memory (ROM) 326, a memory arbiter 324, and local memory 322.

The multimedia processor (MP) 312 within the single mobile multimedia processor chip 300 may comprise suitable circuitry, logic, and/or code and may be adapted to handle, for example, decryption and decoding of multimedia content. The instruction cache 308 may be adapted to store one or more instructions, which may be utilized by the MP 312 during the decryption and/or the decoding. The data cache 310 may be adapted to store data during processing of the multimedia content. The MP 312 may be also adapted to provide a plurality of indicators 303, . . . , 305 to the SC 314, which may be utilized by the SC 314 for generation of a secure bit indicator 306.

In an exemplary embodiment of the invention, the MP 312 may communicate a first indicator 303, which may identify whether the instruction cache 308 was used to process the current instruction. The MP 312 may also communicate a second indicator 304, which may identify whether an interrupt was used to process the current instruction. In addition, the MP 312 may communicate a third indicator 305 to the SC 314, which may specify a program counter value associated with the current instruction of the MP 312. The secure bit indicator 306 may be generated by the SC 314 based on the received indicators 303, . . . , 305, plus the internal state of the SC 314, and may be utilized within the single mobile multimedia processor chip 300 to secure processed multimedia data, such as processed data 307 generated by the MP 312.

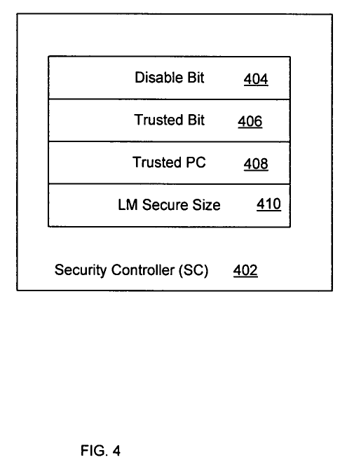

The SC block 314 may comprise suitable circuitry, logic, and/or code and may be adapted to perform security functions related to decrypted and decoded multimedia content within the single mobile multimedia processor chip 300. For example, the SC 314 may be adapted to control whether one or more blocks within the single mobile multimedia processor chip 300 may be designated as trusted or un-trusted for handling decrypted and decoded multimedia content. In an exemplary embodiment of the invention, the SC 314 may also comprise a plurality of registers, which may be utilized by the SC 314 during the security-related functions. Furthermore, one or more registers may be utilized to control use of a secure portion of the local memory 322. The plurality of registers are described below, with regards to FIG. 4.

The SS block 316 may comprise suitable circuitry, logic, and/or code and may be adapted to utilize one or more decryption algorithms, such as data encryption standard (DES) or triple DES (3DES), to facilitate multimedia content decryption by the MP 312. Furthermore, the SS block 316 may be utilized by the MP 312 as storage for one or more secure keys that may be utilized for decryption of encrypted multimedia content.

The boot ROM 326 may comprise suitable circuitry, logic, and/or code and may be adapted to store boot code, which may be utilized during a boot sequence of the single mobile multimedia processor chip 300. In an exemplary embodiment of the invention, boot code stored within the boot ROM 326 may be encrypted for a secure boot sequence.

The local memory 322 may comprise suitable circuitry, logic, and/or code and may be utilized by the single mobile multimedia processor chip 300 for storage of secure and unsecure data. In an exemplary aspect of the invention, the local memory 322 may be divided into a secured and unsecured region, for storage of secure and unsecure data, respectively. The memory arbiter 324 may comprise suitable circuitry, logic, and/or code and may be adapted to control access to the local memory 322. For example, the memory arbiter 324 may be adapted to determine whether processed data is secure, with an asserted bit, prior to granting access to the secured region of the local memory 322.

In operation, input multimedia content 302 may be communicated for processing by the MP 312 within the single mobile multimedia processor chip 300. The MP 312 may utilize the instruction cache 308, the data cache 310 and the SS block 316 during decryption and decoding of the received encrypted and encoded multimedia content 302. The MP 312 may communicate a first indicator 303, which may identify whether the instruction cache 308 was used to process the current instruction. The MP 312 may also communicate a second indicator 304, which may identify whether an interrupt was used to process the current instruction. In addition, the MP 312 may communicate a third indicator 305 to the SC 314, which may specify a program counter value associated with the current instruction.

The SC 314 may then generate the secure bit indicator 306 based on the received first indicator 303, second indicator 304, third indicator 305, and on internal state of the SC 314. The SC 314 may be adapted to secure the multimedia content 307 processed by the MP 312 by setting a bit on the AHB bus in accordance with the generated secure bit indicator 306. For example, if the bit is asserted, the current bus transaction may be considered secure and the source of the transaction may be considered trusted. If the bit is not asserted, the current transaction may be considered unsecure and the source of the transaction may be considered untrusted. The SC 214 may assert or de-assert a bit within processed data communicated via the AHB 218, based on the generated secure bit indicator.

Secure processed data may be stored within a secure portion of the local memory 322. In this regard, the SC 314 may communicate a secured region size value 320 to the memory arbiter 324, and the local memory 322 may set the size of its secured region in accordance with the received size value 320. The memory arbiter 324 may verify that a bit is asserted within the current bus transaction, and the bus transaction may then access the secured region of the local memory 322.

FIG. 4 is a block diagram of an exemplary secure mode controller, which may be utilized in accordance with an embodiment of the invention. Referring to FIG. 4, the security controller (SC) 402 may comprise a plurality of registers 404, . . . , 410, which may be utilized by a single mobile multimedia processor chip, such as the single mobile multimedia processor chip 300 in FIG. 3, with regard to security functionalities related to processed multimedia data. For example, the SC 402 may comprise a disable bit register 404, a trusted bit register 406, a trusted program counter (PC) register 408, and a local memory secure size register 410. The plurality of registers 404, . . . , 410 may be accessed by the SC 402 when the current instruction is secure.

The trusted bit register 406 may be adapted to store a trusted bit value, which may be utilized by the SC 402 during generation of a secure bit indicator, such as the secure bit indicator 306 in FIG. 3. For example, if the trusted bit stored within the trusted bit register 406 is set, for example by setting it to a value of 1, the secure bit indicator generated by the SC 402 may indicate that corresponding processed data is secure and, therefore, a bit of the processed data may be asserted. Similarly, if the trusted bit stored within the trusted bit register 406 is not set, for example by setting it to a value of 0, the secure bit indicator generated by the SC 402 may indicate that corresponding processed data is not secure and, therefore, a bit of the processed data may be de-asserted.

The disable bit register 404 may be adapted to store a disable bit. In an exemplary aspect of the invention, the disable bit may be utilized by the SC 402 to disable the ability to turn the trusted bit, stored by the trusted bit register 406, back on without a reset. In this regard, if the disable bit is set, for example by setting the disable bit to 1, the trusted bit may not be set or turned ON without a reset of the single mobile multimedia processor chip. If the disable bit is not set, for example by setting the disable bit to 0, the trusted bit may be turned ON without a reset of the single mobile multimedia processor chip.

The trusted program counter register 408 may be adapted to store a determined program counter value. In an exemplary embodiment of the invention, the SC 402 may receive a plurality of indicators from a multimedia processor. Referring to FIGS. 3 and 4, the SC 314 may receive indicators 303, . . . , 305 from the MP 312. If the first indicator 303 indicates that the instruction cache 308 was not used during processing of the input data 302, if the second indicator 304 indicates that an interrupt was not used during processing of the input data 302, and if the program counter indicated by the third indicator 305 matches the program counter value stored by the trusted program counter register 408, then the trusted bit stored by the trusted bit register 406 may be set, for example by setting the trusted bit to a value of 1.

The local memory secure size register 410 may be adapted to store a local memory secure size value. Referring to FIGS. 3 and 4, the local memory secure size value stored by the local memory secure size register 410 may be communicated as value 320 to the memory arbiter 324. The memory arbiter 324 may then set the size of a secured region in the local memory 322 based on the local memory size value 320 stored within the local memory secure size register 410.

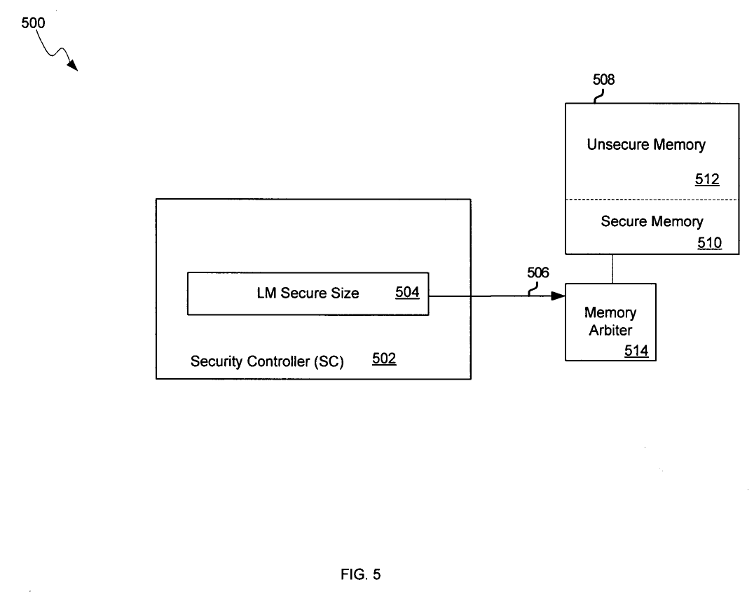

FIG. 5 is a block diagram illustrating secure memory utilization within an exemplary single mobile multimedia processor chip, in accordance with an embodiment of the invention. Referring to FIG. 5, the SC 502 may comprise a plurality of registers, such as the local memory secure size register 504. The local memory secure size register 504 may be adapted to store a local memory secure size value 506, which may be communicated to the memory arbiter 514. The local memory secure size value 506 may be utilized to set a size of a secured region of the local memory 508.

The local memory 508 may comprise suitable circuitry, logic, and/or code and may be utilized for storage of secure and unsecure data. In an exemplary aspect of the invention, the local memory 508 may be divided into a secured memory region 510 and an unsecured memory region 512, for storage of secure and unsecure data, respectively. The memory arbiter 514 may comprise suitable circuitry, logic, and/or code and may be adapted to control access to the local memory 512. For example, the memory arbiter 514 may be adapted to determine whether processed data is secure, with an asserted bit, prior to granting access to a secured region 510 of the local memory 508. Furthermore, the memory arbiter 514 may be adapted to set the size of the secured memory region 510 in the local memory 508, based on the local memory size value 506 stored within the local memory secure size register 504. The local memory secure size register 504 within the SC 502 may be accessed and changed if the processed data comprises an asserted secure bit. The unsecured region 512 of the local memory 508 may be accessed regardless of whether the secure bit of processed multimedia content is asserted or de-asserted.

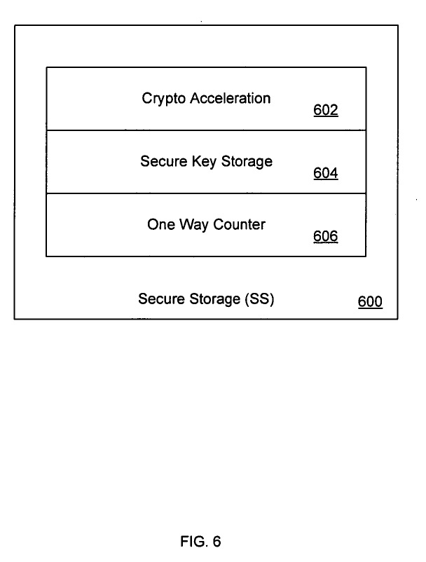

FIG. 6 is a block diagram of an exemplary secure storage (SS) block, which may be utilized in accordance with an embodiment of the invention. Referring to FIG. 6, the SS block 600 may comprise a crypto acceleration block 602, a secure key storage block 604, and a one-way counter block 606. The crypto acceleration block 602 may comprise suitable circuitry, logic, and/or code and may be adapted to utilize one or more decryption algorithms, such as data encryption standard (DES) or triple DES (3DES), to facilitate multimedia content decryption by a multimedia processor, such as the MP 312 in FIG. 3.

The secure storage block 604 may comprise suitable circuitry, logic, and/or code and may be utilized by a multimedia processor, such as the MP 312 in FIG. 3, as storage for one or more secure keys. The secure keys may be utilized for decryption of encrypted multimedia content, for example. The one-way counter 606 may comprise suitable circuitry, logic, and/or code and may be adapted to provide a counter, which may be utilized during digital rights management tasks. For example, the one-way counter block 606 may be utilized for counting a number of accesses, for example by a user, to secured processed data.

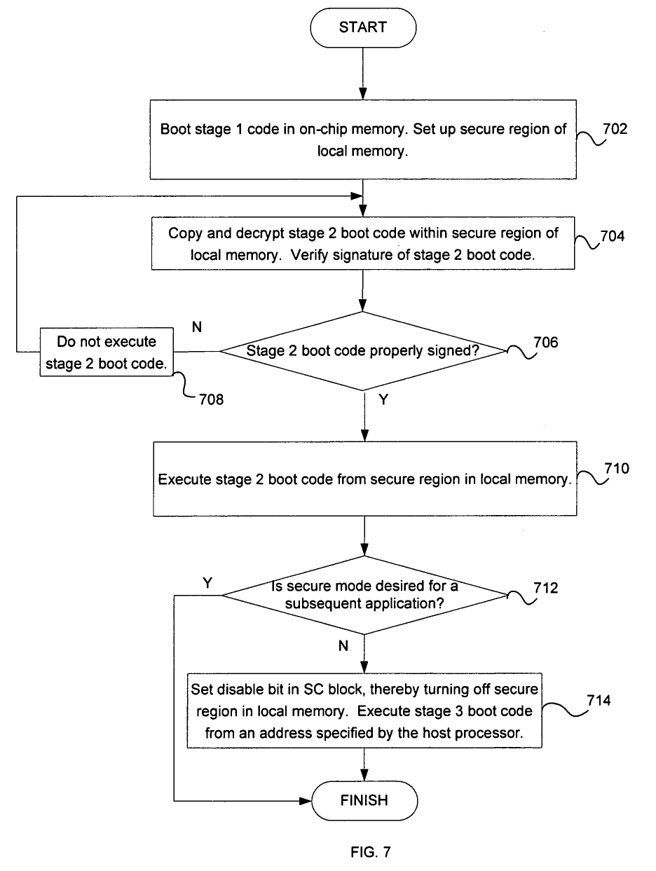

FIG. 7 is a flow diagram illustrating exemplary steps for stage 1, stage 2 and stage 3 boot code sequences, in accordance with an embodiment of the invention. Referring to FIGS. 3 and 7, at 702, stage 1 boot code may be executed from on-chip memory, such as the boot ROM 326. After stage 1 boot code is executed, a secured region of the local memory 322 may be set up. At 704, stage 2 boot code may be copied and decrypted within the secured region of the local memory 322. The signature of the decrypted stage 2 boot code may then be verified. At 706, it may be determined whether the stage 2 boot code is properly signed. If the stage 2 boot code is not properly signed, at 708, stage 2 boot code may not be executed and the operation may resume at step 704. If the stage 2 boot code was properly signed, at 710, stage 2 boot code may be executed from a secure region in the local memory 322. At 712, it may be determined whether secure mode is desired for a subsequent program application. If secure mode is not desired, at 714, a disable bit may be set in a disable bit register within the SC 314, thereby turning off the secured region in the local memory 322. Stage 3 boot code may then be executed from an address specified by, for example, a host processor.

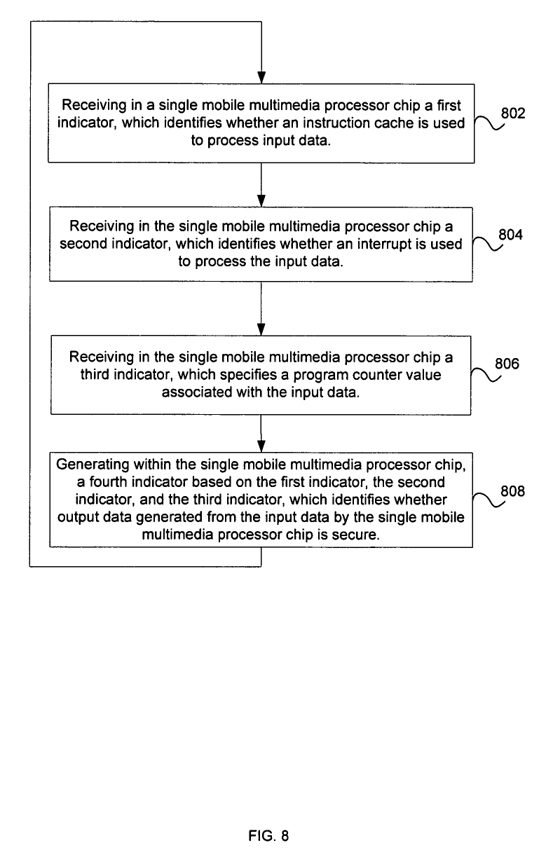

FIG. 8 is a flow diagram illustrating exemplary steps for processing data, in accordance with an embodiment of the invention. Referring to FIGS. 3 and 8, at 802, the SC 314 may receive a first indicator 303, which may identify whether the instruction cache 308 was used to process the input data 302. At 804, the SC 314 may receive a second indicator 304, which may identify whether an interrupt was used to process the input data 302. At 806, the SC 314 may receive a third indicator 305, which may specifies a program counter value associated with the input data 302. At 808, the SC 314 may generate a fourth indicator 306, based on the first indicator 303, the second indicator 304, and the third indicator 305. The fourth indicator 306 may identify whether output data 307 generated from the input data 302 by the single mobile multimedia processor chip 300 is secure.

Referring again to FIG. 3, in accordance with an exemplary embodiment of the invention, a system for processing data may comprise a single mobile multimedia processor chip 300 that receives a first indicator 303, a second indicator 304, and a third indicator 305. The first indicator 303 may identify whether the instruction cache 308 is used to process the input data 302. The second indicator may identify whether an interrupt is used to process the input data 302. The third indicator 305 may specify a program counter value associated with the input data 302. The single mobile multimedia processor chip 300 may generate a fourth indicator 306 based on the first indicator 303, the second indicator 304, and the third indicator 305. The fourth indicator 306 may identify whether output data generated from the input data by the single mobile multimedia processor chip 300 is secure. The single mobile multimedia processor chip 300 may generate a secure bit, based on the received first indicator 303, the second indicator 304, and the third indicator 305.

The single mobile multimedia processor chip 300 may modify at least one bit within the generated output data 307, based on the secure bit. The modified at least one bit may identify whether the output data 307 generated from the input data 302 by the single mobile multimedia processor chip 300 is secure. The single mobile multimedia processor chip 300 may store at least a portion of the output data 307 in a first portion of the local memory 322, if the output data 307 generated from the input data 302 by the single mobile multimedia processor chip 300 is secure. The single mobile multimedia processor chip 300 may store a size value of the first portion of the memory 322, if the output data 307 generated from the input data 302 by the single mobile multimedia processor chip 300 is secure. The single mobile multimedia processor chip 300 may set a size of the first portion of the memory 322 based on the stored size value.

The single mobile multimedia processor chip 300 may disable the generation of the fourth indicator 306 based on the first indicator 303, the second indicator 304, and the third indicator 305. The single mobile multimedia processor chip 300 may store a reference program counter value, where the reference program counter value may be used for the generation of the fourth indicator 306. The single mobile multimedia processor chip 300 may generate the fourth indicator 306, if the first indicator 303 identifies that the instruction cache 308 was not used to process the input data 302, the second indicator 304 identifies that the interrupt was not used to process the input data 302, and the program counter value specified by the third indicator 305 matches the stored reference program counter value. The single mobile multimedia processor chip 300 may count a number of times the output data 307 generated from the input data 302 by the single mobile multimedia processor chip 300 is accessed, if the output data 307 is secure.

Accordingly, aspects of the invention may be realized in hardware, software, firmware or a combination thereof. The invention may be realized in a centralized fashion in at least one computer system or in a distributed fashion where different elements are spread across several interconnected computer systems. Any kind of computer system or other apparatus adapted for carrying out the methods described herein is suited. A typical combination of hardware, software and firmware may be a general-purpose computer system with a computer program that, when being loaded and executed, controls the computer system such that it carries out the methods described herein.

One embodiment of the present invention may be implemented as a board level product, as a single chip, application specific integrated circuit (ASIC), or with varying levels integrated on a single chip with other portions of the system as separate components. The degree of integration of the system will primarily be determined by speed and cost considerations. Because of the sophisticated nature of modern processors, it is possible to utilize a commercially available processor, which may be implemented external to an ASIC implementation of the present system. Alternatively, if the processor is available as an ASIC core or logic block, then the commercially available processor may be implemented as part of an ASIC device with various functions implemented as firmware.

The present invention may also be embedded in a computer program product, which comprises all the features enabling the implementation of the methods described herein, and which when loaded in a computer system is able to carry out these methods. Computer program in the present context may mean, for example, any expression, in any language, code or notation, of a set of instructions intended to cause a system having an information processing capability to perform a particular function either directly or after either or both of the following: a) conversion to another language, code or notation; b) reproduction in a different material form. However, other meanings of computer program within the understanding of those skilled in the art are also contemplated by the present invention.

While the invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiments disclosed, but that the present invention will include all embodiments falling within the scope of the appended claims.

What is claimed is:

1. A method for processing data, the method comprising:
receiving in a single mobile multimedia processor chip at least one indicator relating to how input multimedia data is processed; and
generating within said single mobile multimedia processor chip, a further indicator based on said at least one indicator, which identifies whether output data generated from said input multimedia data by said single mobile multimedia processor chip is secure.

2. The method according to claim 1, wherein said at least one indicator comprises a first indicator, which identifies whether an instruction cache is used to process said input multimedia data, a second indicator, which identifies whether an interrupt is used to process said input multimedia data, and a third indicator, which specifies a program counter value associated with said input multimedia data.

3. The method according to claim 2, further comprising generating within said single mobile multimedia processor chip, a secure bit, based on said received first indicator, said second indicator, and said third indicator.

4. The method according to claim 3, further comprising modifying at least one bit within said generated output data, based on said secure bit, wherein said modified at least one bit identifies whether said output data generated from said input multimedia data by said single mobile multimedia processor chip is secure.

5. The method according to claim 1, further comprising storing at least a portion of said output data in a first portion of a memory on said single mobile multimedia processor chip, if said output data generated from said input multimedia data by said single mobile multimedia processor chip is secure.

6. The method according to claim 5, further comprising storing, within said single mobile multimedia processor chip, a size value of said first portion of said memory, if said output data generated from said input multimedia data by said single mobile multimedia processor chip is secure.

7. The method according to claim 6, further comprising setting a size of said first portion of said memory based on said stored size value.

8. The method according to claim 1, further comprising disabling said generation of said further indicator based on said received at least one indicator.

9. The method according to claim 2, further comprising storing a reference program counter value within said single mobile multimedia processor chip, wherein said reference program counter value is used for said generation of said further indicator.

10. The method according to claim 9, further comprising generating said further indicator within said single mobile multimedia processor chip, if:
said first indicator identifies that said instruction cache was not used to process said input multimedia data;
said second indicator identifies that said interrupt was not used to process said input multimedia data; and
said program counter value specified by said third indicator matches said stored reference program counter value.

11. The method according to claim 1, further comprising, if said output data is secure, counting within said single mobile multimedia processor chip, a number of times said output data generated from said input multimedia data by said single mobile multimedia processor chip is accessed.

12. A machine-readable storage having stored thereon, a computer program having at least one code section for processing data, the at least one code section being executable by a machine for causing the machine to perform steps comprising:
receiving in a single mobile multimedia processor chip at least one indicator relating to how input multimedia data is processed; and
generating within said single mobile multimedia processor chip, a further indicator based on said at least one indicator, which identifies whether output data generated from said input multimedia data by said single mobile multimedia processor chip is secure.

13. The machine-readable storage according to claim 12, wherein said at least one indicator comprises a first indicator, which identifies whether an instruction cache is used to process said input multimedia data, a second indicator, which identifies whether an interrupt is used to process said input multimedia data, and a third indicator, which specifies a program counter value associated with said input multimedia data.

14. The machine-readable storage according to claim 13, further comprising code for generating within said single mobile multimedia processor chip, a secure bit, based on said received first indicator, said second indicator, and said third indicator.

15. The machine-readable storage according to claim 14, further comprising code for modifying at least one bit within said generated output data, based on said secure bit, wherein said modified at least one bit identifies whether said output data generated from said input multimedia data by said single mobile multimedia processor chip is secure.

16. The machine-readable storage according to claim 12, further comprising code for storing at least a portion of said output data in a first portion of a memory on said single mobile multimedia processor chip, if said output data generated from said input multimedia data by said single mobile multimedia processor chip is secure.

17. The machine-readable storage according to claim 16, further comprising code for storing, within said single mobile multimedia processor chip, a size value of said first portion of said memory, if said output data generated from said input multimedia data by said single mobile multimedia processor chip is secure.

18. The machine-readable storage according to claim 17, further comprising code for setting a size of said first portion of said memory based on said stored size value.

19. The machine-readable storage according to claim 12, further comprising code for disabling said generation of said further indicator based on said received at least one indicator.

20. The machine-readable storage according to claim 13, further comprising code for storing a reference program counter value within said single mobile multimedia processor chip, wherein said reference program counter value is used for said generation of said further indicator.

21. The machine-readable storage according to claim 20, further comprising code for generating said further indicator within said single mobile multimedia processor chip, if:
said first indicator identifies that said instruction cache was not used to process said input multimedia data;
said second indicator identifies that said interrupt was not used to process said input multimedia data; and
said program counter value specified by said third indicator matches said stored reference program counter value.

22. The machine-readable storage according to claim 12, further comprising code for counting within said single mobile multimedia processor chip, a number of times said output data generated from said input multimedia data by said single mobile multimedia processor chip is accessed, if said output data is secure.

23. A system for processing data, the system comprising:
a single mobile multimedia processor chip that receives at least one indicator relating to how input multimedia data is processed; and
said single mobile multimedia processor chip generates a further indicator based on said at least one indicator, which identifies whether output data generated from said input multimedia data by said single mobile multimedia processor chip is secure.

24. The system according to claim 23, wherein said at least one indicator comprises a first indicator, which identifies whether an instruction cache is used to process said input multimedia data, a second indicator, which identifies whether an interrupt is used to process said input multimedia data, and a third indicator, which specifies a program counter value associated with said input multimedia data.

25. The system according to claim 24, wherein said single mobile multimedia processor chip generates a secure bit, based on said received first indicator, said second indicator, and said third indicator.

26. The system according to claim 25, wherein said single mobile multimedia processor chip modifies at least one bit within said generated output data, based on said secure bit, wherein said modified at least one bit identifies whether said output data generated from said input multimedia data by said single mobile multimedia processor chip is secure.

27. The system according to claim 23, wherein said single mobile multimedia processor chip stores at least a portion of said output data in a first portion of a memory, if said output data generated from said input multimedia data by said single mobile multimedia processor chip is secure.

28. The system according to claim 27, wherein said single mobile multimedia processor chip stores a size value of said first portion of said memory, if said output data generated from said input multimedia data by said single mobile multimedia processor chip is secure.

29. The system according to claim 28, wherein said single mobile multimedia processor chip sets a size of said first portion of said memory based on said stored size value.

30. The system according to claim 23, wherein said single mobile multimedia processor chip disables said generation of said further indicator based on said received at least one indicator.

31. The system according to claim 24, wherein said single mobile multimedia processor chip stores a reference program counter value, wherein said reference program counter value is used for said generation of said further indicator.

32. The system according to claim 31, wherein said single mobile multimedia processor chip generates said further indicator, if:
said first indicator identifies that said instruction cache was not used to process said input multimedia data;
said second indicator identifies that said interrupt was not used to process said input multimedia data; and
said program counter value specified by said third indicator matches said stored reference program counter value.

33. The system according to claim 23, wherein said single mobile multimedia processor chip counts a number of times said output data generated from said input multimedia data by said single mobile multimedia processor chip is accessed, if said output data is secure.
